(19) United States
(12) Patent Application Publication
(10) Pub. No.: US 2020/0057918 A1
(43) Pub. Date: Feb. 20, 2020

(54) SYSTEMS AND METHODS FOR TRAINING ARTIFICIAL INTELLIGENCE TO PREDICT UTILIZATION OF RESOURCES

(71) Applicant: Perfect Price, Inc., Oakland, CA (US)

(72) Inventors: Young In Shin, Palo Alto, CA (US); Hsinyu Yao, Oakland, CA (US); Alexander C. Shartsis, Piedmont, CA (US)

(73) Assignee: Perfect Price, Inc., Oakland, CA (US)

(21) Appl. No.: 16/543,424

(22) Filed: Aug. 16, 2019

Related U.S. Application Data
(60) Provisional application No. 62/765,119, filed on Aug. 17, 2018.
(60) Provisional application No. 62/840,342, filed on Apr. 29, 2019.

(51) Int. Cl. G06K 9/62; G06N 7/00; G06N 20/00; G06Q 30/02

(52) U.S. Cl. CPC G06K 9/6257; G06Q 30/0206; G06N 20/00; G06N 7/005

(57) ABSTRACT

A computer system trains an artificial intelligence (AI) implemented on the computer system. The computer system includes one or more processors that are configured to receive historical transaction data for a set of resources, where the historical transaction data includes positive examples relating to purchases of one or more resources of the set of resources. The one or more processors are also configured to derive augmented data from the historical transaction data, where the augmented data includes negative examples relating to fictional non-purchase decisions for the set of resources. The one or more processors are further configured to determine a training set for a machine learning algorithm for the AI, where the training set includes the historical transaction data and the augmented data. The one or more processors are configured to train the AI using the machine learning algorithm based on the training set.

### CROSS-REFERENCE TO RELATED PATENT APPLICATIONS

This application claims the benefits and priorities of U.S. Provisional Patent App. No. 62/840,342, filed on Apr. 29, 2019 and U.S. Provisional Patent App. No. 62/765,119, filed on Aug. 17, 2018, the entire contents of each of which are incorporated by reference herein.

### TECHNICAL FIELD

The present disclosure relates generally to systems and methods for machine learning and artificial intelligence (AI), and in particular embodiments, to computer systems and methods for improving AI to predict market demand and prices for resources.

### BACKGROUND

Machine learning is often considered a subset of artificial intelligence in which computer systems perform tasks by relying on patterns and inferences. As part of machine learning, computer systems may be programmed with algorithms that rely on models to make predictions or decisions. Technical problems arise when computer systems programmed with machine learning algorithms have unsound models or unstable models, because unsound models and unstable models can lead to wrong predictions or wrong decisions by the computer systems.

### SUMMARY

Various systems and methods disclosed herein provide improvements in the technical field of artificial intelligence through the development of techniques for training an artificial intelligence implemented on a computer system. Various techniques for training an artificial intelligence as disclosed herein provide for stable models for the artificial intelligence and can improve the predictive capabilities of the artificial intelligence. The trained artificial intelligence may be used to predict market demand and prices for resources.

A method in accordance with various arrangements for training an artificial intelligence (AI) implemented on a computer system includes receiving, over a network by the computer system, historical transaction data for a set of resources, where the historical transaction data includes positive examples relating to purchases of one or more resources of the set of resources. The method also includes deriving, by the computer system, augmented data from the historical transaction data, where the augmented data that is derived includes negative examples relating to fictional non-purchase decisions for the set of resources. The method further includes determining, by the computer system, a training set for a machine learning algorithm for the AI, where the training set comprises the historical transaction data including the positive examples and the augmented data including the negative examples. The method also includes training, by the computer system, the AI using the machine learning algorithm based on the training set.

In various arrangements, the deriving, by the computer system, of the augmented data from the historical transaction data includes determining, by the computer system, a generative probability density function from the positive examples. In some arrangements, the deriving, by the computer system, of the augmented data from the historical transaction data further includes determining, by the computer system, an inversion of the generative probability density function, and generating, by the computer system, the negative examples using the inversion of the generative probability density function. Also, in some arrangements, the determining, by the computer system, of the generative probability density function from the positive examples includes finding, by the computer system, one or more Gaussian functions using the positive examples.

In some arrangements, the computer system enforces boundary limitations for values of the positive examples. In various arrangements, the deriving, by the computer system, of the augmented data from the historical transaction data includes limiting, by the computer system, a number of the negative examples that are derived based on a number of the positive examples. In some arrangements, the negative examples are estimated by the computer system from a distribution of the positive examples. Also, in some arrangements, the historical transaction data includes one or more of event data, inquiry data, competitor data, or transactional data.

In various arrangements, the method further includes storing the historical transaction data, cleaning, by the computer system, the historical transaction data, and transforming, by the computer system, the historical transaction data into a different format. In some arrangements, the method further includes predicting, by the AI after the training, a set of prices corresponding to the set of resources. Also, in some arrangements, the method further includes determining, by the AI after the training, predicted demand for the set of resources, and the set of prices is predicted by the AI based on the predicted demand. In various arrangements, the training, by the computer system, of the AI using the machine learning algorithm based on the training set includes training the AI using a classification algorithm that uses both the positive examples and the negative examples. Also, in various arrangements, the machine learning algorithm is a supervised learning algorithm.

A computer system in accordance with various arrangements for training an AI implemented on the computer system includes one or more processors that are configured to receive, over a network, historical transaction data for a set of resources, where the historical transaction data includes positive examples relating to purchases of one or more resources of the set of resources. The one or more processors are also configured to derive augmented data from the historical transaction data, where the augmented data that is derived includes negative examples relating to fictional non-purchase decisions for the set of resources. The one or more processors are further configured to determine a training set for a machine learning algorithm for the AI, where the training set comprises the historical transaction data including the positive examples and the augmented data including the negative examples. The one or more processors are also configured to train the AI using the machine learning algorithm based on the training set.

A non-transitory computer-readable medium in accordance with various arrangements stores computer-readable instructions such that, when executed, cause a computer system to train an AI implemented on the computer system by receiving, over a network, historical transaction data for a set of resources, where the historical transaction data includes positive examples relating to purchases of one or more resources of the set of resources. The instructions when executed also cause the computer system to derive augmented data from the historical transaction data, where the augmented data that is derived includes negative examples relating to fictional non-purchase decisions for the set of resources. The instructions when executed further cause the computer system to determine a training set for a machine learning algorithm for the AI, where the training set comprises the historical transaction data including the positive examples and the augmented data including the negative examples. The instructions when executed also cause the computer system to train the AI using the machine learning algorithm based on the training set.

In various arrangements, the deriving of the augmented data from the historical transaction data includes determining a generative probability density function from the positive examples. Also, in various embodiments, the deriving of the augmented data from the historical transaction data further includes determining an inversion of the generative probability density function, and generating the negative examples using the inversion of the generative probability density function. In some arrangements, the determining of the generative probability density function from the positive examples includes finding one or more Gaussian functions using the positive examples. Also, in some arrangements, there are boundary limitations for values of the positive examples. In various arrangements, the negative examples are estimated from a distribution of the positive examples.

### BRIEF DESCRIPTION OF THE DRAWINGS

FIG. 1 is a graph illustrating example demand functions fit using training examples.

FIG. 2 is a graph illustrating an example for fitting functions using training data, according to various arrangements disclosed herein.

FIG. 3 is a block diagram illustrating an example of a computer system for training an artificial intelligence to be capable of predicting demand and/or prices for resources, according to various arrangements disclosed herein.

FIG. 4 is flowchart diagram illustrating a method for a computer system with an artificial intelligence to allocate a set of resources of an organization for utilization, according to various arrangements disclosed herein.

FIG. 5 is a diagram illustrating a computer system receiving categories of data items over a network, according to various arrangements disclosed herein.

FIG. 6 is a flowchart diagram illustrating a method for a computer system with an artificial intelligence to allocate a set of resources of an organization for utilization, according to various arrangements disclosed herein.

FIG. 7 is a flowchart diagram illustrating a method for a computer system with an artificial intelligence to allocate a set of resources of an organization for utilization, according to various arrangements disclosed herein.

FIG. 8 is a flowchart diagram illustrating a method for a computer system with an artificial intelligence to allocate a set of resources of an organization for utilization, according to various arrangements disclosed herein.

FIG. 9 is a graph illustrating an example demand prediction for a vehicle rental, according to various arrangements disclosed herein.

FIG. 10 is a flowchart diagram illustrating a method for training an artificial intelligence to predict demand and prices for resources, according to various arrangements disclosed herein.

FIG. 11A is a flowchart diagram illustrating a method for training an artificial intelligence implemented on a computer system, according to various arrangements disclosed herein.

FIGS. 11B, 11C, 11D, 11E, 11F, 11G, 11H, and 11I illustrate steps that can be used with the method in FIG. 11A, according to various arrangements disclosed herein.

### DETAILED DESCRIPTION

Referring generally to the figures, various arrangements disclosed herein provide systems and methods for transforming transactional data for stable machine learning (ML) of demand characteristics. Various arrangements provide for a demand learner framework for an artificial intelligence.

As used herein, a “set” includes at least one member.

In some examples, a “resource” is a product or service that can be licensed, rented, or sold, and that is subject to demand based on market factors. A set of resources may include, for example, cars, hotel rooms, airline seats, tickets to sports and performances, rides in a vehicle, or other resources.

In some examples, “event data” includes data external to immediate circumstances of the set of resources, such as data about school holidays, public holidays, days for religious observances, civic events, conferences, expos, concerts, festivals, performing arts events, sporting events, community events, dates of a shift to or from daylight savings time, airport delays, severe weather, disasters, terrorism events, or other types of events.

In some examples, “inquiry data” includes data reflecting consumer behavior in seeking information for potential utilization of the set of resources, such as behavior including activity in using the World Wide Web to seek for information pertinent to the set of resources.

In some examples, “competitor data” refers to data reflecting activity of competitors in the marketplace for alternatives to the set of resources.

In some examples, “transactional data” refers to data reflecting consumer transactions for utilization of the set of resources, including potentially information regarding purchases, rentals, leases, and other economic relationships enabling utilization of the set of resources.

In some examples, “cost data” of a set of resources of an organization refers to data characterizing costs borne by the organization to make the set of resources available to consumers.

In some examples, “location” refers to a physical place where a resource in the set of resources is made available to a consumer, such as a warehouse, depot, store, rental car lot (when the resource is a rental car), parking lot (where the resource is a parking space), hotel (where the resource is a hotel room), airport or airport gate (where the resource is a seat on an airplane), etc.

In some examples, a “computer process” is the performance of a described function in a computer using computer hardware (such as a processor, field-programmable gate array or other electronic combinatorial logic, or similar device), which may be operating under control of software or firmware or a combination of any of these or operating outside control of any of the foregoing. All or part of the described functions may be performed by active or passive electronic components, such as transistors or resistors. The term “computer process” does not necessarily require a schedulable entity, or operation of a computer program or a part thereof, although, in some arrangements, a computer process may be implemented by such a schedulable entity, or operation of a computer program or a part thereof. Furthermore, unless the context otherwise requires, a “process” may be implemented using more than one processor or more than one (single- or multi-processor) computer.

A computer system in accordance with some arrangements includes one or more processors configured to execute instructions from machine-readable media to construct training examples (e.g., a training set) from historical transaction data in a way that improves model soundness of a model learned at least in part from the training examples. In various arrangements, the computer system includes a plurality of computers that are connected over a network.

A computer system in accordance with some arrangements includes one or more processors configured to execute instructions from machine-readable media to auto-segment a dataset into two or more groups and to learn a model for each of the two or more groups. In some embodiments, the instructions further cause the one or more processors to search for an optimal amount of data that provides semantic individuality in each of the two or more groups with a minimum number of segments of the dataset.

A computer system in accordance with some arrangements includes one or more processors configured to execute instructions from machine-readable media to augment data for generating a model by adding to the data a zero-price training example with a high probability of sales or a large sales volume.

A computer system in accordance with some arrangements includes one or more processors configured to execute instructions from machine-readable media to augment data for generating a model by adding training examples to the data at lower price points than the price points that are currently in the data.

A computer system in accordance with some arrangements includes one or more processors configured to execute instructions from machine-readable media to augment data for generating a model by adding training examples to the data in such a way as to avoid higher valued products being priced cheaper than lower valued products.

A computer system in accordance with some arrangements includes one or more processors configured to execute instructions from machine-readable media to formulate a market demand estimation problem as a classification problem in machine learning or artificial intelligence and organize training data accordingly.

A computer system in accordance with some arrangements includes one or more processors configured to execute instructions from machine-readable media to perform a negative density estimation to construct negative examples in a data-driven way to be used as training examples for generating a model.

The present disclosure relates to computer systems, methods, and program products on machine-readable media for accomplishing various operations. A computer system in accordance with various arrangements includes one or more computer processors and machine-readable media for carrying or having machine-executable instructions and data structures stored therein or thereon. By way of example, such machine-readable media can include random access memory (RAM), read only memory (ROM), erasable programmable read-only memory (EPROM), electrically erasable programmable read-only memory (EEPROM), compact disc-read-only memory (CD-ROM), or other optical disk storage, magnetic disk storage or other magnetic storage devices, or any other medium which can be used to carry or store program code in the form of machine-executable instructions or data structures which can be accessed by the one or more computer processors. Such machine-readable media includes non-transitory computer-readable media. Combinations of the above are also included within the scope of machine-readable media. Machine-executable instructions include, for example, instructions and data which cause the one or more computer processors to perform a certain function or group of functions. The machine-executable instructions may be executed by the one or more computer processors. In various arrangements, a computer system includes a plurality of computers that are connected over a network for executing the machine-executable instructions.

Learning market demand as a mathematical function of price and other relevant contextual parameters is often the most critical first step in price optimization and revenue management. Existing solutions from studies such as traditional operational research (OR) or economics have limitations that cannot meet the level of technical sophistication of massive amounts of complicated user data collected from various channels on which customers transact. That is, traditional methods of manually determining prices and demands for resources lack the sophistication to provide meaningful results based on the massive amounts of complicated user data. Machine learning (ML) and artificial intelligence (AI) techniques have shown strengths in learning knowledge from such massive and complex datasets and are known to show improved prediction results over those determined manually. However, the nature of such datasets and the subject problems do not allow for a straightforward and stable application of existing ML and AI techniques. A successful application of ML and AI techniques to market demand estimation needs an effective formulating of a market demand estimation problem into a supervised learning task or other task to train the AI to generate accurate predictions. Various arrangements described herein provide computer systems and methods for problem formulation that allows not only solving the problem using ML and AI techniques but also improving the economic soundness of generated models.

For example, in a conventional economics and operational research model, demand is a decreasing function (f) of price (p) that maps to a volume of sales (v) at each price. Learning in this context applies only a limited set of mathematical transformations, e.g., scaling and translation of the function to fit to a historical transaction dataset (S) defined as:

S={(pᵢ,vᵢ)| for i=1, . . . ,l} (1).

The function being a decreasing function of price is used to make economic optimizations. The function being an increasing function of price suggests that increasing the price to infinity corresponds to infinite revenue, which is non-sense. Such a function can suffer from side effects such as a poor and slow fitting, thus losing sight of important unforeseen phenomena underneath the data without having appropriate models to address such phenomena.

In some examples, ML and AI models may have soundness issues. ML and AI techniques are typically agnostic of any domain knowledge of the real-world problems to which the ML and AI techniques are applied. ML and AI techniques typically solve abstracted mathematical problems purely represented by training examples, each of which is a D-dimensional feature vector v=(f₁, f₂, . . . , f_{D}). Quality of learned models are measured in a few standardized metrics such as f-score, precision/recall, and so on. Such abstraction often takes domain knowledge away during problem formulation and thus results in ML/AI-wise models being non-sense. Such non-sense models cannot be used in a specific domain to which the models are applied.

In addition, ML and AI models may have model stability issues. For example, models evolve as more data are injected via repeated learning. Depending on how ML and AI models are formulated, the resulting models can become unstable, and output (e.g., prices) can fluctuate excessively. This is often fatal in providing predictions and needs to be avoided as much as possible.

In accordance with various arrangements disclosed herein, a computer system executes algorithms for ML and/or AI to provide price optimization and revenue management through ML and/or AI, while improving model soundness and model stability. In some arrangements, a training set (including training examples) is constructed from historical transactional data in a manner that improves model soundness. As described herein, improving model soundness can be achieved by microsegmentation and data and/or model augmentation. In various arrangements, microsegmentation is the task of dividing an entire dataset into smaller groups, where the models can learn from each of such smaller groups of datasets. In some examples, groups can share certain subset(s) of the dataset as needed (e.g., there can be overlaps in data between two groups). Particular criteria or parameters used to organize the dataset into the smaller groups may vary depending on specifics and characteristics of the dataset and the problem. In some arrangements, a market demand estimation problem is formulated as a classification problem in ML and/or AI context, and the training data is organized accordingly.

In training an AI to predict pricing, demand characteristics greatly vary over different transactions, such that a global model trained using the entire dataset may learn nothing from the entire dataset. That is, the models trained using the entire dataset may become confused and give up further learning. Such models are ineffective in estimating demands for any specific market or product. Various arrangements of the present disclosure relate to auto-segmenting an entire dataset into smaller groups that maximizes accuracy of models learned individually from each of the separated groups. This auto-segmentation is achieved in various arrangements by searching for an optimal amount of data that allows semantic individuality in each group with a minimum number of segments. This also allows for synthesis of microsegments for markets for which very little or no data is available, thus providing estimation of market demand with improved accuracy.

In some examples, data and/or model augmentation relate to the effort of enriching an input dataset to ensure model soundness for ML/AI. Although specific augmentation implementations can vary, augmentation methods can share a common theme of imposing sound economic assumptions about human behaviors underlying the market demand and translating and/or encoding them during training example generation and model learning. As such, the arrangements disclosed herein relate to improving input data (e.g., training sets and training examples) to an ML algorithm to train the AI to make predictions of demand and prices with improved accuracy.

In various arrangements, zero-price examples relating to a high probability of sales or a large sales volume are added, based on the assumption that many customers will certainly take free products and services. In other words, economic principles are enforced in ML and AI using the zero-price examples. With proper tuning, the inclusion of zero-price examples can ensure that the demand function is a decreasing function of price.

In some arrangements, it is assumed that customers who purchased at a certain price point would welcome lower price points. As such, training examples at lower price points are added. In other words, economic principles are enforced in ML and AI using the examples at the lower price points. This can reduce or avoid anomalies in AI prediction results showing higher valued products/services being priced cheaper than lower valued products/services. In various arrangements, a number of lower price point examples to be added and associated importance (e.g., weights) are determined for ML. Various arrangements are directed to the entire methodologies that allow for both manual or data-driven data and/or model augmentation.

Another feature described herein relates to providing for model stability. In various arrangements, a demand function (f) is a component in later optimization operations that produce pricing decisions as optimal prices found by computing gains (such as but not limited to, revenue, profit, utilization, or the like) using the demand function. In some situations, the market demand can be very sensitive to price (p) such that a slight change in training data can cause huge fluctuations in the final optimized price points. In operational research or economics, the demand function is often modeled as a function that maps price to the sales volume, which is an unbounded quantity and is found via regressing over historical transactional data. Unless the training data is sufficiently condensed, regressed functions over an unbounded target quantity suffer from swinging while fitting with incremental data. That is, approaches such as the implementation of regressed functions that work well for traditional manual prediction methods (e.g., via operational research or economics) may not work for ML and AI.

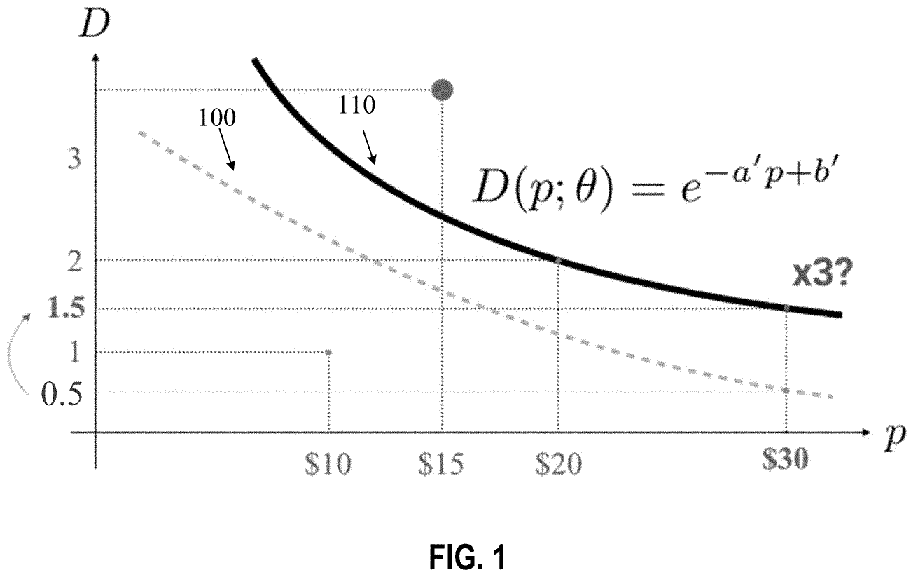

FIG. 1 is a graph illustrating example demand functions that are fit using training examples. Referring to FIG. 1, a demand function 100 for a particular resource (e.g., a product or service), shown as a dashed curve, is fit using two training examples: {($10, 1), ($20, 2)}. The x-axis corresponds to price (p) while the y-axis corresponds to demand (D). Based on the training examples, the AI predicts ($30, 0.5), which means that if the price is set at $30, then it is likely that 0.5 units of the resource can be sold. With a new training example of ($15, 4) added, a new demand function 110 is fit to a new curve, which is shown as a solid curve. The new demand function 110 forecasts that 1.5 units will be sold instead of 0.5 units at the price of $30. The result determined using the new demand function 110 is a 200% increase from the previous result determined using the demand function 100. That is a large swing in prediction from a single added training example.

Various arrangements disclosed herein prevent such significant model swings by reformulating demand estimation from a regression to classification. While a regressed demand function maps price to an unbounded sales volume, various arrangements relate to finding one or more demand functions that map price to a probability φ that a product will be sold at that price. Because the probability φ is a bounded quantity in [0, 1], model swing can be greatly reduced.

In various arrangements, reformulating demand estimation as a classification problem includes balanced positive and negative training examples. In some instances, historical transaction data includes information relating to purchases made in the past, including but not limited to, prices at which products and/or services are sold and/or other contextual parameters (e.g., time, location, and so on). In various arrangements, the historical transaction data constitutes only positive training examples. Classifiers (components of AI for decision-making) trained using only positive examples learn nothing from the positive examples because the classifiers do not know what is “wrong” and only what is “right.” Various arrangements disclosed herein handle this issue pertaining to AI and ML by constructing negative examples in a data-driven way so that the AI models are trained over reasonably well-balanced training datasets. In some examples, constructing the negative examples from the positive examples involves negative density estimation and a simulation process.

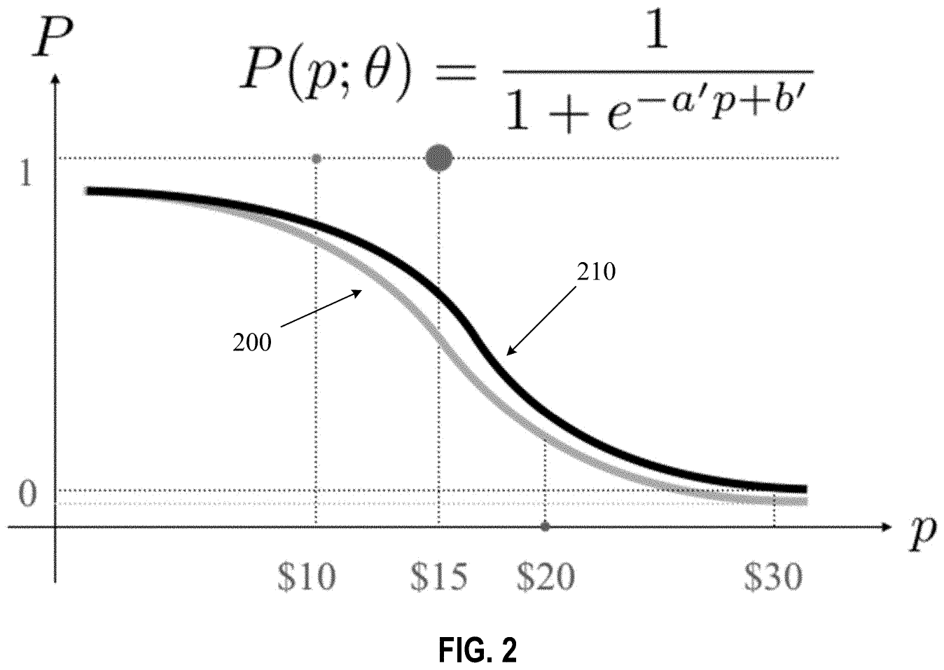

FIG. 2 is a graph illustrating an example for fitting functions using training data, according to various arrangements disclosed herein. A function 200 is fit using two training examples: {($10, 1), ($20, 0)}. Label 1 on the y-axis indicates that a product or service is purchased, and label 0 on the y-axis indicates that a product or service is not purchased. The function 200 predicts an outcome of ($30, 0.1), which means that it is likely that 0.1 unit of product will be sold if the product is priced at $30. With a new training data of ($15, 1), a new function 210 can be determined to fit to a new curve. The new function 210 forecasts that 0.13 units will be sold instead of 0.1 units if the product is priced at $30. This is a 30% increase from the previous guess, meaning that the models underlying the functions 200 and 210 are much more stable than in regression with an unbounded target.

Thus, various arrangements as disclosed herein provide an effective systematic process to frame supervised learning using an unlabeled dataset. Various arrangements described herein provide a novel approach that enables learning demand as a classifier from unlabeled transactional datasets.

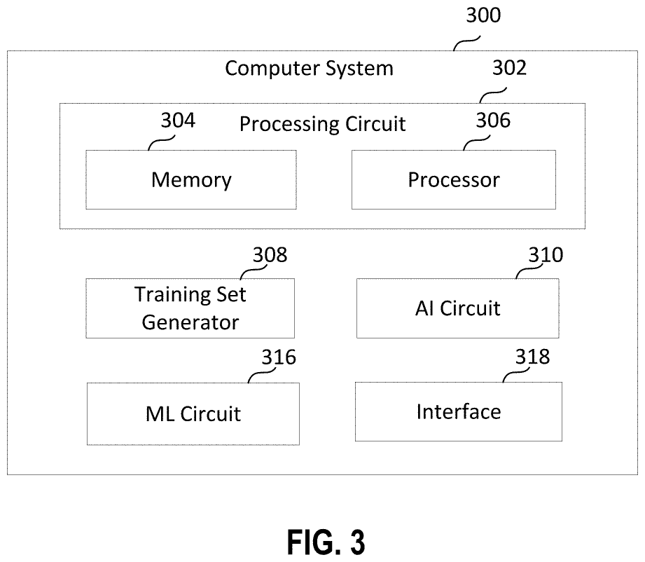

FIG. 3 is a block diagram illustrating an example of a computer system 300 capable of predicting prices and/or demand for resources, according to various arrangements disclosed herein. Referring to FIG. 3, the computer system 300 can provide accurate estimates of prices and/or demand with stable outputs. As shown, the computer system 300 includes a processing circuit 302, a training set generator 308, an artificial intelligence (AI) circuit 310, a machine learning (ML) circuit 316, and an interface 318 for implementing features described herein. In some arrangements, the computer system 300 is a part of a workstation computer or another suitable computing device. The computer system 300 may include other devices such as but not limited to, a network system, a wireless or wired communications system, printers, and/or the like not shown for brevity. In some arrangements, the computer system 300 includes a plurality of computers that are connected by a network.

The processing circuit 302 includes a memory 304 and a processor 306. The processor 306 includes any suitable data processing device, such as a general-purpose processor (e.g., a microprocessor). In the alternative, the processor 306 can be any conventional processor, controller, microcontroller, or state machine. The processor 306 can be implemented as a combination of computing devices, e.g., a combination of a Digital Signal Processor (DSP) and a microprocessor, a plurality of microprocessors, at least one microprocessor in conjunction with a DSP core, or any other such configuration.

The memory 304 (or storage device) is a computer-readable medium and can be operatively coupled to the processor 306 and can include any suitable device for storing software instructions and data for controlling and use by the processor 306 to perform operations and functions described herein. Examples of the memory 304 include, but are not limited to, RAM, ROM, floppy disks, hard disks, dongles or other connected memory devices, or the like. The memory 304 can include non-transitory storage media that is configured to store information and instructions pertinent to the operation of the processor 306.

The memory 304 can send data to or receive data from the processor 306 and/or each of the training set generator 308, AI circuit 310, ML circuit 316, and interface 318 in the computer system 300. In some examples, the memory 304 can be a remote storage device that stores data for the computer system 300 (or only the processing circuit 302) in a different node of a network than that on which the processing circuit 302 and/or the computer system 300 reside. In some examples, the memory 304 can be located on the same computer system (e.g., within the same node of the network) as the processing circuit 302 and/or the computer system 300. In some examples, one or more of the training set generator 308, AI circuit 310, ML circuit 316, and interface 318 can be implemented with a dedicated memory unit that is separate from the memory 304. In some arrangements, one or more of the training set generator 308, AI circuit 310, ML circuit 316, and interface 318 can be implemented by software run by the processing circuit 302.

The processing circuit 302 can implement or otherwise provide processing capabilities to one or more of the training set generator 308, AI circuit 310, ML circuit 316, and interface 318 in the computer system 300 for performing the features described herein. For example, the processing circuit 302 can implement the training set generator 308 to generate training sets (including training examples) for training an AI (implemented by the AI circuit 310) via suitable ML algorithms (executed by the ML circuit 316). The training set generator 308 can generate a training set including one or more of positive examples, negative examples, zero-price training examples, lower price point training examples, and so on, in the manner described herein.

In some arrangements, the processing circuit 302 implements the AI circuit 310. The AI circuit 310 is configured to provide an AI that predicts prices and demands for resources based on input parameters. Furthermore, in various arrangements, the processing circuit 302 implements the ML circuit 316. The ML circuit 316 trains the AI based on the training sets generated by the training set generator 308. The ML circuit 316 implements one or more suitable ML algorithms. In some examples, the ML algorithms include a supervised learning algorithm, such that one or more human operators can provide user input corresponding to desired outcomes (e.g., desired predicted prices and demands for resources) corresponding to the training examples included in the training set. In various arrangements, both the training examples and the user input of the desired outcomes are labeled and/or classified to train the classifier of the AI. In various arrangements, the AI generates patterns and inferences based on correlations between the training examples and the user input of the desired outcomes. In various arrangements, the patterns and inferences are organized into models that make up a classifier of the AI. The trained AI can be used by the AI circuit 310 to predict prices and/or demands for resources.

In various arrangements, the interface 318 includes at least one input device for receiving user input from a human operator and at least one display device for outputting information to the human operator. For example, the interface 318 can include a monitor, keyboard, keypad, mouse, joystick, touch screen display, or other input and/or output devices performing a similar function. The keyboard can include alphanumeric and other keys, and can be connected to processing circuit 302 for communicating information and command selections. The input device can include a touch screen interface or movement sensing interface that can be combined with, or separated from, a display device of the interface 318. The input device can include a cursor control device, such as, but not limited to, a mouse, trackball, touch screen, motion sensor, cursor direction keys, or the like. Such input device can control cursor movement on the display device. The display device of the interface 318 can be any type of display (e.g., Cathode Ray Tube (CRT) display, Liquid Crystal Display (LCD), etc.) configured to provide audio and/or visual output to the user. In some examples, a human operator can provide user input corresponding to desired outcomes corresponding to training examples via the interface 318. In various arrangements, the processing circuit 302 is connectable to a network for sending and receiving data.

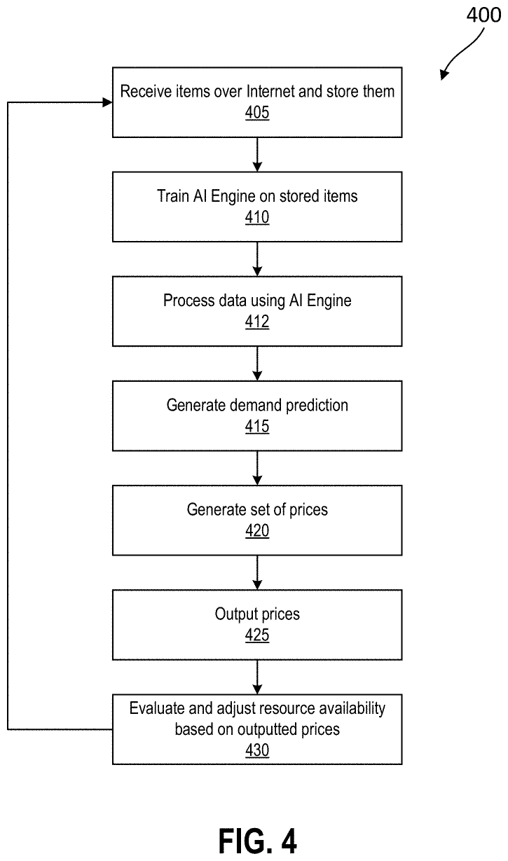

FIG. 4 is flowchart diagram illustrating a method 400 for a computer system with an artificial intelligence to allocate a set of resources of an organization for utilization, in accordance with some arrangements. Referring to FIGS. 3 and 4, at block 405, the computer system 300 receives categories of data items over a network (e.g., the Internet) and stores the data items. The data items include historical transaction data in some examples.

At block 410, the ML circuit 316 uses the stored data items to train an AI engine (e.g., the AI circuit 310) to generate a prediction of demand for a set of resources to be allocated. In various arrangements, the training at block 410 is performed using a training set generated in the manner described herein.

At block 412, the AI circuit 310 processes some or all of the stored data items, and at block 415, the AI circuit 310 generates a prediction of demand for the resources corresponding to the stored data items. At block 420, the AI circuit 310 uses the prediction of demand from block 415 to generate a set of prices for the resources.

At block 425, the AI circuit 310 produces an output of the prices for implementation. At block 430, the AI circuit 310 evaluates an availability of the set of resources on the basis of the prices produced as an output at block 425 and adjusts such availability if needed by the evaluation. After block 430 is performed, the method 400 returns to block 405. Given that the business operations to which the method 400 is applicable may be ongoing and dynamic (e.g., additional data can be received at block 405 on an on-going, dynamic basis, in real time), blocks 405, 410, 412, 415, 420, 425, and 430 may be repeated periodically (e.g., daily, hourly, and so on) or continuously performed in real time.

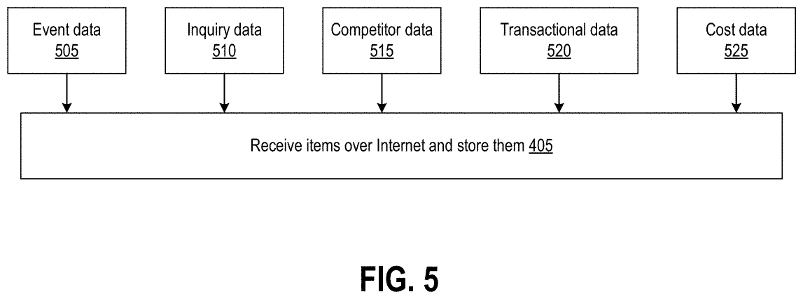

FIG. 5 is a diagram illustrating a process of a computer system receiving categories of data items over a network, according to various arrangements disclosed herein. Referring to FIGS. 3, 4, 5, data items received by the computer system 300 over a network, such as the Internet, at block 405 can belong to one or more of the data item categories shown in FIG. 5. For example, the received data items can be event data 505 (such as but not limited to, information relating to the weather and holidays), inquiry data 510 (such as but not limited to, information relating to requests for price quotations or estimates initiated by potential customers), competitor data 515 (such as but not limited to, pricing information of competitors), transactional data 520 (such as but not limited to, actual purchases or bookings for use of the resources), cost data 525 (such as but not limited to, cost of providing the resources to be allocated), and so on.

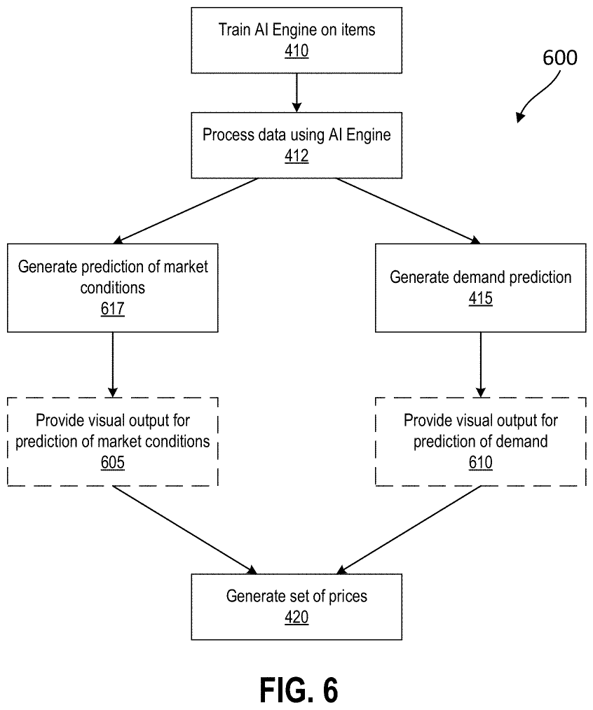

FIG. 6 is flowchart diagram illustrating a method 600 for a computer system with an artificial intelligence to allocate a set of resources of an organization for utilization, in accordance with some arrangements. Referring to FIGS. 3, 4, and 6, the method 600 of FIG. 6 differs from the method 400 of FIG. 4 in that the AI circuit 310 also generates market condition predictions. At block 410, the ML circuit 316 uses the stored data items (received at block 405) to train an AI engine (e.g., the AI circuit 310) to generate a prediction of demand for the set of resources to be allocated. At block 412, the AI circuit 310 processes some or all of the stored data items, and at block 415, the AI circuit 310 generates a prediction of demand for the resources corresponding to the stored data items.

At block 617, the AI circuit 310 generates a prediction of market conditions, such as but not limited to, availability of competitive and other resources (of the same or similar nature, characteristics, or usage as the resources for which prices and demands are to be predicted by the AI circuit 310), and the existence of no shows in the marketplace. In some examples, optionally, at block 605 and block 610 respectively, the interface 318 provides visual outputs for the prediction of market conditions and of demand for the resources to be allocated. The visual outputs can be provided in, for example, a text format, a chart format, a table format, a graphic format, and/or the like. The visualizations can be used to help client organizations to handle the overwhelming amount of data, often numbering into ten thousand rows for even a relatively small location or timeframe. The visual outputs in various arrangements are provided with the ability to filter data and to quickly change the layout, so as to facilitate making sense of the large amount of data. After providing the visual outputs, the AI circuit 310 generates a set of prices for the set of resources at block 420, based on the prediction of market conditions and the demand prediction.

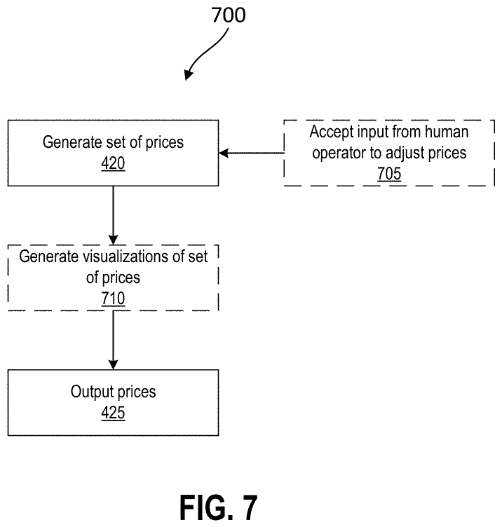

FIG. 7 is flowchart diagram illustrating a method 700 for a computer system with an artificial intelligence to allocate a set of resources of an organization for utilization, in accordance with some arrangements. Referring to FIGS. 3, 4, and 7, the method 700 differs from the method 400 in that the computer system 300 can receive and accept inputs from a human operator via the interface 318, at block 705, for generating the set of prices at block 420 before the visualization of the set of prices is generated at block 710. In some arrangements, the AI without human input may be accurate 85-90% of the time. Real world decisions and business owners require close to 100% accuracy. However, to obtain such accuracy, human input may be needed to supplement the AI-based computer system 300. In some arrangements, an intuitive interface is provided via the interface 318 that handles the scale of data required, and allows for incorporating outside factors for overriding the outputs of the AI circuit 310. In some examples, optionally, before providing the set of prices as an output at block 425, a visualization of the set of prices is generated at block 710.

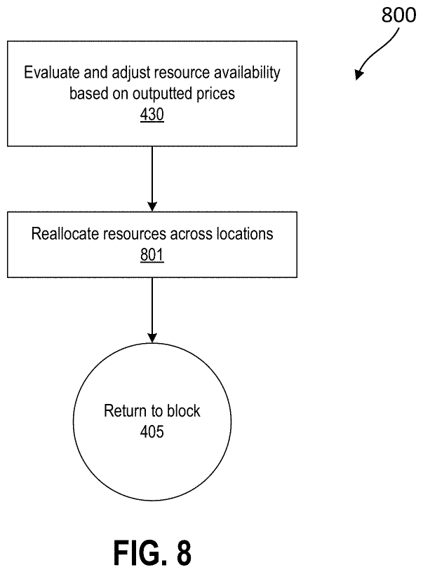

FIG. 8 is flowchart diagram illustrating a method 800 for a computer system with an artificial intelligence to allocate a set of resources of an organization for utilization, in accordance with some arrangements. Referring to FIGS. 3, 4, and 8, the method 800 of FIG. 8 differs from the method 400 of FIG. 4 in that resources are reallocated across locations. For example, after evaluating and adjusting resource availability based on outputted prices at block 430, the computer system 300 evaluates the availability of the set of resources on the basis of the prices produced as an output at block 425 and adjusts such availability if needed by the evaluation. At block 801, the computer system 300 reallocates the set of resources across locations where the resources are distributed. Thereafter, the method 800 returns to block 405 of FIG. 4, i.e., block 801 is added after block 430 and before block 405.

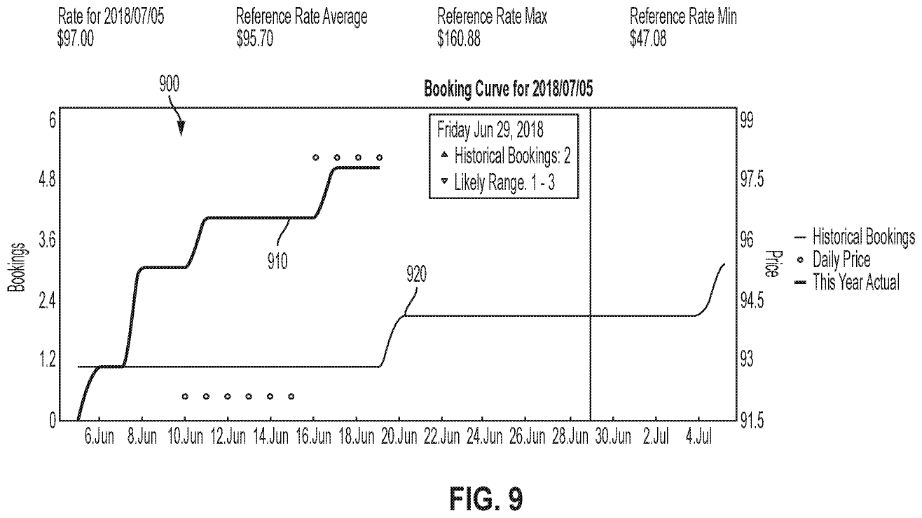

FIG. 9 is a graph illustrating an example of demand prediction 900 for a vehicle rental on July 5, as evaluated on June 18. Referring to FIGS. 3 and 9, the example demand prediction 900 shows a trend running far ahead of expectations. An actual booking curve 910 corresponds to the actual bookings and is shown by the single line running up to June 19 with the level of bookings indicated on the left-hand vertical axis. A prediction curve 920 corresponds to the prediction running through July 5. Each black dot represents a booking transaction, with the price referenced on the right-hand vertical axis. As shown, the booking price experienced a significant jump between June 16 and June 18. In some arrangements, the demand prediction 900 can be output by the interface 318 to a user or operator.

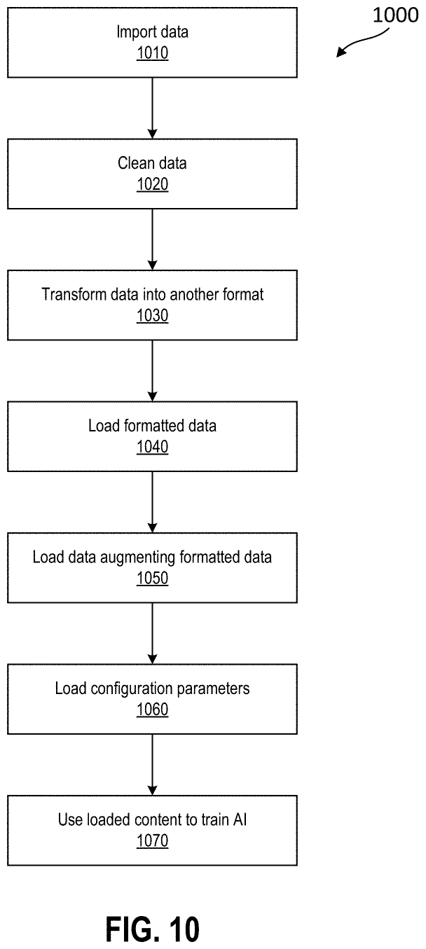

FIG. 10 is a flowchart diagram illustrating a method 1000 for training an AI to predict demand and prices for resources, according to various arrangements disclosed herein. Referring to FIGS. 3 and 10, the method 1000 is carried out by a computer system, such as the computer system 300, programmed to perform the method 1000.

At block 1010, raw data to be used to train an AI is imported. The raw data can be received by a network device (not shown) of the computer system 300 via a network (e.g., the Internet). The importation can be achieved using various methods. In a first method, a client company (company that provides the data) stores its data on the computer system 300 directly using the secure file transfer protocol (SFTP) protocol. In a second method, a client company uses an application programming interface (API) associated with operations of the computer system 300. The API sends the data to the computer system 300 using hypertext transfer protocol secure (HTTPS) and representational state transfer (REST) protocols. In a third method, the API of the computer system 300 is configured to pull data onto the computer system 300 from a node of the client company using HTTPS and REST protocols. In a fourth method, the data of the client company is streamed (e.g., using Kafka® and HTTPS).

With reference to FIGS. 3, 4, 5, and 10, in some examples, the raw data imported at block 1010 corresponds to the data items received at block 405. For example, the raw data imported at block 1010 can be the event data 505, inquiry data 510, competitor data 515, transactional data 520, cost data 525, and so on. In some examples, the transactional data 520 includes positive transaction examples. The positive transaction examples correspond to transactions for purchases of resources that have been completed (e.g., the resources have been purchased). In some arrangements, the positive transaction examples include price, date at which the resources have been purchased, duration of use for the resources, and so on. The positive transaction examples can be used as positive training examples in the training set as described herein.

At block 1020, the raw data is cleaned by the computer system 300. In some examples, cleaning the raw data includes verifying the formatting of the raw data. In response to determining that the imported raw data is already in a working format (e.g., JavaScript Object Notation (JSON)) acceptable by the computer system 300, the computer system 300 validates the raw data and copies the raw data from a set of receiving servers of the computer system 300 to an AI-ready Apache Hadoop set of servers, in an arrangement in which the computer system 300 includes such servers. In some arrangements, the AI circuit 310, the training set generator 308, and the ML circuit 316 are implemented as software on an AI-ready Apache Hadoop set of servers.

In some arrangements, if the imported raw data is in a relational database (RDB) format, such as a structure query language (SQL) format, or flattened comma-separated value (CSV) files, the computer system 300 utilizes a tool such as “SQL to JSON” converter that converts SQL files into JSON files so the imported data can be stored in the Apache Hadoop set of servers. The tool enables a developer or an end user to configure different fields for the source and destination, and map the source to destination fields. Thus, when the data are read in, the data is moved into the correct field in one step, without writing to disk twice. This approach is much faster than writing the data and trying to reorganize the data once it is written.

In various arrangements, after the data has been imported and stored, the data is further cleaned by the computer system 300. The further cleaning includes subjecting the data to quality control using automated tools and removing erroneous data. In automated cleaning, for example, a transaction that was resent but occurred over a predetermined length of time (e.g., over 1 day, 1 month, 1 year, 10 years, and so on) can be discarded. Data relating to a transaction occurring on a future date (e.g., the date of the purchase is erroneously labeled for a future date) can be discarded. Statistical outliers (e.g., a transaction with a price that is 10 times higher than any other prices ever charged for a resource) can be discarded. A variety of tools (e.g., including ML and simple moving averages, and so on) can be used to perform further cleaning.

At block 1030, the computer system 300 transforms the data into a format for consumption by the AI engine (e.g., by the ML circuit 316 and the AI circuit 310). The format is referring to an organization or syntax for expressing the data that is acceptable to the ML circuit 316. For example, the ML circuit 316 in various arrangements is typically programed to expect usage of a resource to be specified in a data structure of “1 day×30 days for a 30-day reservation.” If the data is not in this format, then the data are converted. Another example is a booking priced at a weekly rate of $100 per week. Information for such a booking can be converted into a daily willingness to pay (e.g., $100/7 per day). In various arrangements, daily figures are employed because not all customers want to utilize a given resource for an entire week.

At block 1040, after the data have been properly formatted and cleaned, the formatted data is loaded into the ML circuit 316 (e.g., the Apache Hadoop cluster). The data is in the format (e.g., JSON) the AI circuit 310 or the ML circuit 316 is expecting. The data has fields (e.g., resources or inventory) that the AI circuit 310 or the ML circuit 316 is expecting.

At block 1050, the ML circuit 316 loads data that augments the formatted data previously loaded at block 1040. In various arrangements, the computer system 300 augments the formatted data to generate augmented data (e.g., negative examples, zero-price training examples, lower price point training examples, and so on). The positive examples imported at block 1010 may be insufficient for training the AI by themselves, and training an AI on insufficient data can result in highly volatile outputs (e.g., prices), which would likely be rejected by human customers and therefore by managers of the business. The augmented data can be used to prevent this outcome.

In some arrangements, the negative examples refer to fictional negative examples to balance out the previously loaded data (e.g., positive examples). In various arrangements, the fictional negative examples correspond to fictional non-purchases of the set of resources. Negative examples (such as fictional examples where a price for a resource was presented and the consumer chooses not to utilize or buy the resources) can be added in the vicinity of real positive examples.

The negative examples would not be needed if perfect data on shopping and interest regarding the resources were available. However, such perfect data is almost never available as many companies do not track closely their phone calls and website visits, and tie those occurrences directly to a purchase or reservation. In other words, real-world negative examples where purchases are not made are difficult to track. In fact, doing so is very difficult in an age of phones, tablets, mobile devices, and the Internet. Therefore, augmenting of the imported data (the positive examples) with generated negative examples is needed to ensure that the predicted prices are reasonable and stable.

In some examples, the ML algorithm (e.g., for modeling of prices and demand) is a supervised learning algorithm. Supervised learning for training the AI can benefit from a balanced set of positive and negative examples. In various arrangements, an example is positive within the context of price and demand prediction if the example signals increase in demand volume or probability. The raw data received at block 1010 may contain only actual transaction data where purchases have been made, which is by nature positive. Hence, it may be difficult to obtain real world negative examples, which are uncompleted transactions or inquires that could not be converted to sales. Most companies do not have such negative transactional examples to obtain. Any model trained using supervised learning based on one-sided labels may end up learning very little or nothing given that the training set includes only positive examples.

In some arrangements, negative examples are derived or estimated by the computer system 300 from the distribution of positive datasets including the positive examples. Such methods of derivation correspond to determining a relative absence of data that is considered as negative. The relative absence of data within the distribution of the positive examples being negative examples is a reasonable assumption as the range of feature values of the positive examples are bounded. For instance, a month-of-year feature is a value within the range of [0, . . . , 11] (e.g., 0 being January, 11 being December). The generative probability density function can be estimated from the positive examples (e.g., prices can be high during peak seasons like June to August, and low over other months of the year). In some examples, the inversion of the generative probability density function corresponds to the negative examples. This approach allows formulation of a supervised learning problem using only positively labelled examples, because the positive examples can be used to derive or estimate the negative examples.

As an illustration, a positive example can be a user renting a car, where the rental transaction takes the form of historical transaction data in which the price is $100.00/day, and the date and time of reservation includes pickup (on July 29) and drop off (on July 31), with a total of two days (excluding the return date). The positive example can be converted into two daily positive examples:

Features x_i=(p, m, w, d) with label y_i:
x_0=($100, 6, 31, 1), y_0=1
x_1=($100, 6, 31, 2), y_1=1
   where p is used to represent price, month m=6 means July, week w=31 means 31st week of year, day d=1 means Monday, d=2 means Tuesday.

In some examples, responsive to converting historical transactions into positive examples where y_i=1, a generative probability density function can be fitted by determining a mixture of Gaussian functions in a space of (m, w, d), where the space corresponds to boundary limitations of the positive examples. Numerically, this means finding a mixture of Gaussian functions in the space of (m, w, d) that minimizes the error from the positive examples while the area under this function remains as close to 1 in order to be a valid probability density function. In some examples, the computer system 300 includes a numerical open source library used to estimate the probability density function.

In an example involving month m, due to the nature of the business, a number of positive examples over the space of m can be [0, 0, 0, 0, 1, 2, 3, 4, 0, 0, 0, 0]. Each number in the set corresponds to sales made in an associated month. For instance, no sales are made from January to April and from September to December. The number of sales start from May (sale=1 unit of the resource) and peaks in August (sale=4 units of the resource). An example discrete probability density function can be [0.01, 0.01, 0.03, 0.05, 0.1, 0.2, 0.25, 0.25, 0.05, 0.03, 0.01, 0.01], the sum of which is 1. In some examples, the probability density function can be normalized using linear transformation, an example of which is shown as expression (2) with p representing probability in the equation:

[p−min(p)]/[max(p)−min(p)] (2).

For example, normalizing the discrete probability density function using expression (2) yields dataset [0.0, 0.0, 0.08, 0.17, 0.38, 0.79, 1.0, 1.0, 0.17, 0.08, 0.0, 0.0]. The normalized discrete probability density function can be inverted by using expression (3) with p representing probability in the equation:

1−p (3).

The inversion of the probability density function indicates a set probability that positive examples will not happen, i.e., hypothetical, fictional negative examples occur. For example, the inversion of the discrete probability density function can be [0.99, 0.99, 0.97, 0.95, 0.9, 0.8, 0.75, 0.75, 0.95, 0.97, 0.99, 0.99]. The inversion can be normalized (e.g., using expression (2)), yielding normalized inversion [1.0, 1.0, 0.92, 0.83, 0.63, 0.21, 0.0, 0.0, 0.83, 0.92, 1.0, 1.0]. Although the resulting dataset includes a series of probabilities that is not a true probability density function given that the sum of all data points is not 1, the normalized inversion can be transformed to be a true probability density function by dividing the number at each data point (each month) by the sum of the numbers at all data points, in order to allow the generation process to converge faster.

After the inversion is determined, the computer system 300 randomly generates examples in (m, w, d), where the samples are the negative examples. In some examples, the computer system 300 retrieves the randomly generated samples from an open source library. In other examples, an example in (m, w, d) is randomly selected and a random probability is generated to compare against the inverted probability density function. Responsive to determining that the random probability of the example is less than the inverted probability, then the example is considered a valid negative example and accepted. On the other hand, responsive to determining that the random probability of the example is greater or equal to the inverted probability, then the example is considered an invalid negative example and rejected.

In some examples, the negative examples have the syntax of the positive examples, except that the negative examples are labeled −1 by setting y_i=−1 for the negative examples. In various arrangements, the inverted probability density function does not include price feature. This is based on the assumption that during the period that the negative examples are sampled, the price used in that negative transaction is the price of the nearest positive example. For instance, if a new negative example is generated between x_0 and x_1:

x_0=($100,6,31,1),y_0=1;

x_1=($100,6,31,2),y_1=1;

then price is $100 for this negative example because the price is assumed to have remained unchanged between x_0 and x_1.

The estimating of the negative examples is grounded on the assumption that the positive examples are bounded or have boundary limitations. A bounded feature has values that are bounded within the boundary limitations. For example, a day-of-week feature is bounded within [0, . . . , 6], a month-of-year feature is bounded within [0, . . . , 11]. On the other hand, price (e.g., [0, infinity]) is unbounded on at least one side. In other words, a bounded feature has values that are within a range, and any values outside the range are invalid. Examples with feature values outside of valid range are discarded or are designed to throw exceptions. For example, m=12 (a transaction occurring on 13th month) is meaningless. Bounded features give a foundation for the absence of positives. Knowing that values can occur only within the boundary limitations and with a sufficiently large number of positive examples, the lack of positive examples can be used as proxies for negative examples.

In some arrangements, deriving the augmented data (the negative examples) from the historical transaction data (the positive examples) includes limiting a number of the negative examples that are derived based on a number of the positive examples. The number of negative examples that are generated can depend on the number of positive examples available that are used to derive the negative examples. In some examples, a fixed or predetermined ratio between positive examples and negative examples is used, such that the number of negative examples derived using the positive examples can be calculated by multiplying the number of available positive examples and the ratio.

In some arrangements, positive examples that have a quality score above a threshold are selected. The quality score can also be used to determine the number of best/optimal/good negative examples. In some examples, the quality score is an Fi score. A range of possible number or ratio of negative examples relative to the positive examples can be considered.

At block 1060, the AI configuration is loaded into the computer system 300. The configuration data specifies assumptions and parameters governing operation of the AI engine. For example, in various arrangements, the configuration data specify types of modeling used such as but not limited to, linear regression, classification, and so on. The configuration data may be specified by the end user or the operator of the computer system 300 via the interface 318.

At block 1070, the previously loaded content, including the initially loaded formatted data (including the positive examples), the augmented data (including the negative examples), and the configuration data, are used to train the AI by the computer system 300. In various arrangements, the computer system 300 trains the AI multiple times because each training result is dependent on an order in which data is read into the AI. For example if a product is sold at prices of $1, $1, $1, $10, $100, and $100 and the sales data are read into the computer system 300 in that order, the AI may conclude, after being trained using such data, that the price should be close to $1 owing to the initial sales success at that price. If the same data is loaded in reverse order, the AI may conclude, after being trained using such data, that the correct price is close to $100. By randomizing and repeating the ML process, the AI can establish more accurate demand for a given resource. The AI output from the ML process is then created as a model file, which may be loaded elsewhere.

In some arrangements, the output of the AI is essentially an equation for demand across every “micro segment,” which is defined as the least common denominator of resources. Such output is not human readable, and does not provide a coefficient for parameters such as “weather” or “chance of thunderstorm.”

In the context of a car rental company, for example, the AI output can be a specific car on a specific time period for a specific length of rent from a specific origin to a specific destination. An example would be for a compact car picked up at 6:00 AM on Jul. 18, 2018 at Austin Bergstrom airport, in Austin, Tex. and returned on Jul. 19, 2018 at 6:00 PM at Dallas Fort Worth airport in Dallas, Tex. In the context of the ground transport company as another example, the AI output could be information for a shuttle pick-up, such as a shuttle pick up at the Hilton Downtown San Francisco at 12:35 PM on Jul. 3, 2018 and dropped off at the Oakland airport.

In some examples, classification by the AI (executed by a classifier of the AI) can be performed using the positive examples and the negative examples. Classification is the task of deciding a label (e.g., + or −) of an unseen example. As such, the classifier is learned from examples labeled as + and −. The result of the classifier can be either the label itself (+ or −) or a continuous output within a bounded range (e.g., typically [0, 1]). The input example is classified as positive if output is ≥0.5, and negative otherwise.

Using the negative examples to train the AI allows the formulation of demand modeling as a supervised learning problem (e.g., a classification problem). Using isotonic functions like logistic curves enforces that demand is inversely proportional to the price, thus eliminating non-sense results such as an increase in price corresponds to increases in demand, based on which the price is set to infinity for an infinite amount of sales. This also avoids overfitting due to function smoothness via its monotonicity. Isotonic functions are functions where output exhibits monotonicity (i.e. constantly non-decreasing) as input increases. Such functions are therefore by definition smooth (no valleys or peaks), including only one single hill. Hence, such output suffers less from small or big oscillations and prevents overfitting. If otherwise such oscillations are allowed, then the learned function can over-fit.

Learned models in ML can be presented by logit/logistic functions in some examples. Smoothness of logistic functions and models (achieved by avoiding overfitting) is the largest advantage. The arrangements disclosed herein relating to converting historical transaction data into both positive (+) and negative (−) examples leverages the stability and soundness of learned models that are represented by the logistic functions. Accordingly, historical transactional data is reorganized to allow for the formulation of the demand modeling problem of the AI into a supervised learning paradigm.

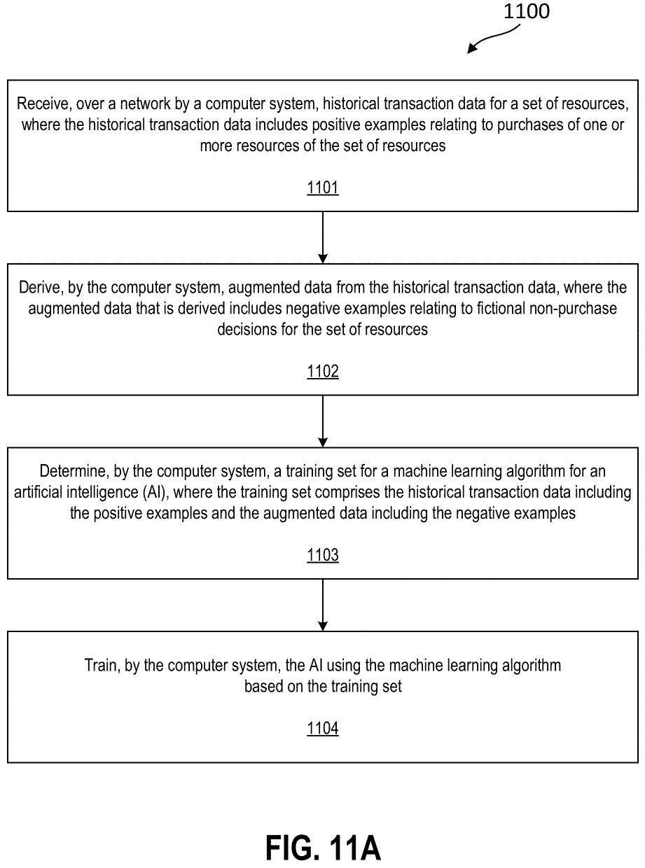

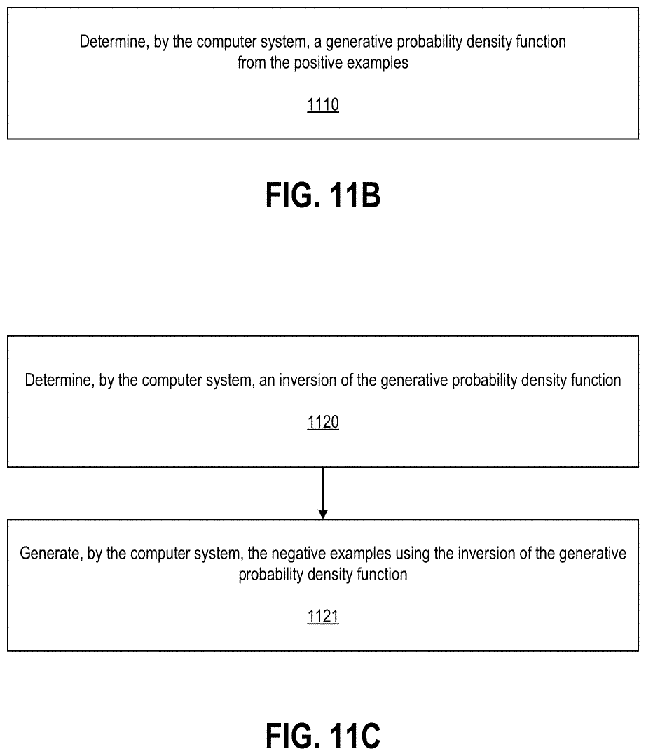

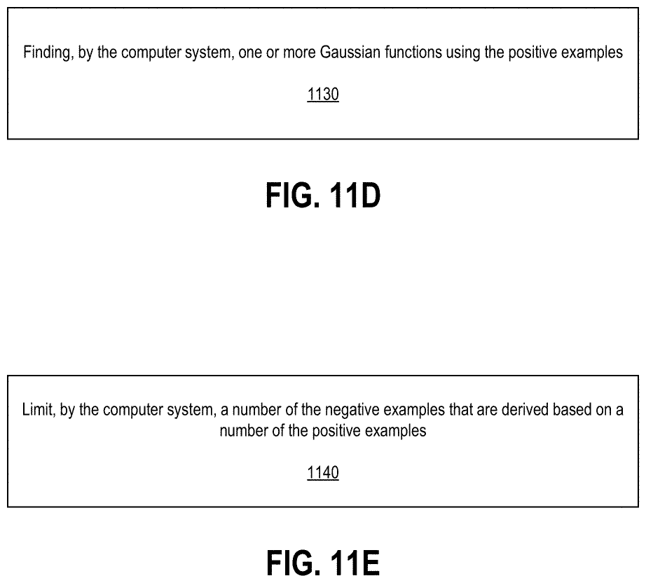

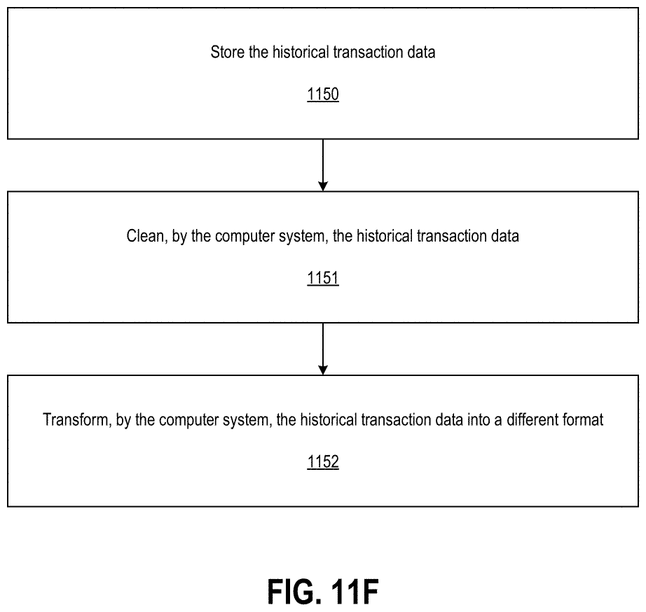

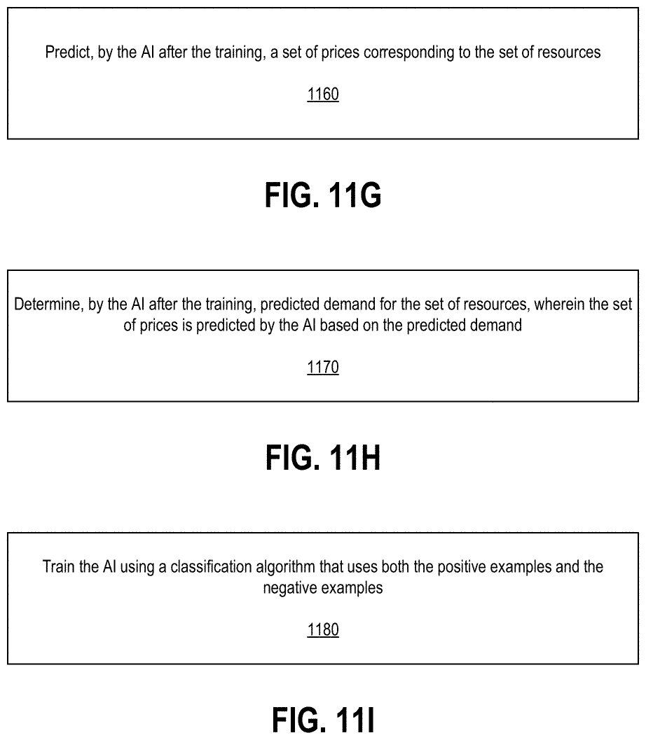

FIG. 11A is a flowchart diagram illustrating a method 1100 for training an artificial intelligence implemented on a computer system, such as the computer system 300 of FIG. 3. With reference to FIGS. 3 and 11A, the method 1100 in accordance with various arrangements allows for training an AI implemented on the computer system 300. At block 1101, the computer system 300 receives, over a network, historical transaction data for a set of resources, where the historical transaction data includes positive examples relating to purchases of one or more resources of the set of resources. At block 1102, the computer system 300 derives augmented data from the historical transaction data, where the augmented data that is derived includes negative examples relating to fictional non-purchase decisions for the set of resources. At block 1103, the computer system 300 determines a training set for a machine learning algorithm for the AI, where the training set comprises the historical transaction data including the positive examples and the augmented data including the negative examples. At block 1104, the computer system 300 trains the AI using the machine learning algorithm based on the training set.

FIGS. 11B, 11C, 11D, 11E, 11F, 11G, 11H, and 11I illustrate steps that can be used with the method 1100 in FIG. 11A. With reference to FIGS. 3, 11A, 11B, 11C, 11D, 11E, 11F, 11G, 11H, and 11I, in various arrangements, the deriving in block 1102, by the computer system 300, of the augmented data from the historical transaction data includes the step of block 1110 of determining, by the computer system 300, a generative probability density function from the positive examples. In some arrangements, the deriving in block 1102, by the computer system 300, of the augmented data from the historical transaction data further includes the step of block 1120 of determining, by the computer system 300, an inversion of the generative probability density function, and also includes the step of block 1121 of generating, by the computer system 300, the negative examples using the inversion of the generative probability density function. Also, in some arrangements, the determining in block 1110, by the computer system 300, of the generative probability density function from the positive examples includes the step of block 1130 of finding, by the computer system 300, one or more Gaussian functions using the positive examples.

In some arrangements, the computer system 300 enforces boundary limitations for values of the positive examples. In various arrangements, the deriving in block 1102, by the computer system 300, of the augmented data from the historical transaction data includes the step of block 1140 of limiting, by the computer system 300, a number of the negative examples that are derived based on a number of the positive examples. In some arrangements, the negative examples are estimated by the computer system 300 from a distribution of the positive examples. Also, in some arrangements, the historical transaction data includes one or more of event data, inquiry data, competitor data, and/or transactional data.

In various arrangements, the method 1100 further includes storing the historical transaction data (block 1150), cleaning, by the computer system 300, the historical transaction data (block 1151), and transforming, by the computer system 300, the historical transaction data into a different format (block 1152). In some arrangements, the method 1100 further includes the step of block 1160 of predicting, by the AI after the training, a set of prices corresponding to the set of resources. Also, in some arrangements, the method 1100 further includes the step of block 1170 of determining, by the AI after the training, predicted demand for the set of resources, and then the set of prices is predicted by the AI based on the predicted demand. In various arrangements, the training in block 1104, by the computer system 300, of the AI using the machine learning algorithm based on the training set includes the step of block 1180 of training the AI using a classification algorithm that uses both the positive examples and the negative examples. Also, in various arrangements, the machine learning algorithm is a supervised learning algorithm.

In various arrangements, the computer system 300 includes the processor 306 or may have one or more processors like the processor 306 that are configured to perform the method 1100 and the steps that can be used with the method 1100. In various arrangements, a non-transitory computer-readable medium stores computer-readable instructions such that, when executed, cause the computer system 300 to perform the method 1100 and the steps that can be used with the method 1100.

In various arrangements, the deriving of the augmented data from the historical transaction data includes determining a generative probability density function from the positive examples. Also, in various embodiments, the deriving of the augmented data from the historical transaction data further includes determining an inversion of the generative probability density function, and generating the negative examples using the inversion of the generative probability density function. In some arrangements, the determining of the generative probability density function from the positive examples includes finding one or more Gaussian functions using the positive examples. Also, in some arrangements, there are boundary limitations for values of the positive examples. In various arrangements, the negative examples are estimated from a distribution of the positive examples.

### EXAMPLE USE CASES

### Example 1

Car Rental. As an example, assume that there is a car rental company called Acme Car Rental (Acme) that is a national car rental company. In the example, assume that Acme operates 10,000 cars across 25 locations. Acme can use a resource allocation system based on an arrangement disclosed herein to manage its resources throughout the day. As an example, every day, multiple times per day, data may be collected and sent to the resource allocation system, which generates prices and movements to ensure availability of vehicles at locations where Acme can profit the most and please its customers. For example, Austin, Tex. may be a location served by Acme having an unusually high demand event—in this example, the South By Southwest conference. The data will show that competitors have increased price and calculate the likelihood that they will sell out or run out of vehicles. Furthermore, the AI engine may suggest that Acme itself is likely to sell out. Thus, the AI engine would enable Acme to move vehicles to the Austin, Tex. market in time to fulfill the additional demand, provided that the oversupply of vehicles in the following days and weeks will not result in lost revenue in other locations (from which the vehicles would have been moved, or other places to which the vehicles could be moved) that would remove the benefit of moving vehicles into Austin.

### Example 2

Ground transport company. As another example, assume that there is a ground transport company named SpecialShuttle, which offers riders a way to and from different destinations in urban areas. For example, a customer may wish to go from the customer's home to the airport, or from the airport to a hotel, or from one point of interest to another. Using the resource allocation system based on an arrangement of the present disclosure, SpecialShuttle may ensure every hour the best quality of service, and competitiveness with other participants in the market. As an example, every day, multiple times per day, data relating to demand of passengers and availability of drivers and vehicles of different classes, may be collected and sent to the resource allocation system. Additional data on weather, flight delays, local events, holidays, etc. are also collected and inserted into the resource allocation system. The resource allocation system then calculates the demand of the various different services for each time of the day, including, in this example, for walk-up customers who do not book in advance but rather approach an airport counter or open a mobile application to request a ride at the time they want it, “on demand.” The resource allocation system computes demand and optimizes the price and availability such that the system achieves the optimal utilization set by its human operators. For periods of peak demand, the resource allocation system may adjust things such as price, but also availability of different vehicle classes, in order to ensure availability even for walk-up customers at the last minute-when otherwise there would be no availability as all vehicles would be 100% utilized. As a result, SpecialShuttle is able to grow its business and compete in a very competitive marketplace, by maximally utilizing its resources and reaching the largest number of customers.

### Example 3

Apparel Retail company. As yet another example, assume there is an apparel retail company named I&J, which is a global vertically integrated apparel retailer, with 1,000 stores around the US and abroad, each selling approximately 2,000 different garments or accessories depending on the season. In the example, assume that I&J is primarily judged based on its profitability and its sales per square foot of store space. Using the resource allocation system based on an arrangement of the present disclosure, the store may ensure that the correct resources (apparel for example) are in the correct locations at the correct times. Because the utility of the resources to end customers varies dramatically by time of year, time of week, and even the weather or other events (festivals, etc.) and all of these conditions occur on a very local level, possibly only affecting one or two stores out of 1,000, the resource allocation system has to take into account vast amounts of data. By creating accurate predictions of demand based on these various data, the resource allocation system can direct the availability, and, in some cases, price or discounting of different resources. When a resource is no longer desirable by consumers, the resource must be quickly removed from the space it occupies as it reduces the sales per square foot metric. Therefore the resource allocation system can identify these slow-moving products and make adjustments to encourage consumers to physically remove them and thus enable better utilization of the store or distribution center space with a new, higher-demand product.

### Example 4

Grocery Delivery. As another example, assume that a grocery delivery service named Farmers delivers groceries to the doorstep or hands of a customer at the customer's home. Further assume that Farmers does this with nominal or no delivery fees, operating with lean supplies out of small distribution centers to enable fast inexpensive delivery. The resource allocation system of an arrangement of the present disclosure may be used to ensure that the distribution centers have stocked and are selling in-demand products. Demand for products can vary by time of day, day of week, week of year, season, weather, and local events among other factors. The resource allocation system takes these factors into account using the AI engine, and predicts when a product has or will become less desirable. It then decides how best to remove that product from circulation, whether by destroying it, selling at a discount (and if so determining the level of the discount) or other actions to affect availability. With that item thus removed within the specified timeframe by either the AI engine or the human operator, a new item is able to take its place in the limited distribution center space and improve sales and utilization of the service.

The arrangements disclosed herein are to be considered in all respects as illustrative, and not restrictive of the disclosure. The present disclosure is in no way limited to the arrangements described above. Various modifications and changes may be made to the arrangements without departing from the spirit and scope of the disclosure.

The present disclosure may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA)), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, networker, or locator.) Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCM CIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over a communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD) or a hardware description language (e.g., VHDL or AHDL).

While the disclosure has been particularly shown and described with reference to specific arrangements, it will be understood by those skilled in the art that various changes in form and detail may be made therein without departing from the spirit and scope of the disclosure. While some of these arrangements have been described in the claims by process steps, an apparatus comprising a computer with associated display capable of executing the process steps in the claims below is also included in the present disclosure. Likewise, a computer program product including computer executable instructions for executing the process steps in the claims below and stored on a computer readable medium is included within the present disclosure.

The arrangements of the disclosure described above are intended to be merely exemplary; numerous variations and modifications will be apparent to those skilled in the art. All such variations and modifications are intended to be within the scope of the present disclosure as defined in any appended claims.

What is claimed is:

1. A method for training an artificial intelligence (AI) implemented on a computer system, the method comprising:
receiving, over a network by the computer system, historical transaction data for a set of resources, wherein the historical transaction data includes positive examples relating to purchases of one or more resources of the set of resources;
deriving, by the computer system, augmented data from the historical transaction data, wherein the augmented data that is derived includes negative examples relating to fictional non-purchase decisions for the set of resources;
determining, by the computer system, a training set for a machine learning algorithm for the AI, wherein the training set comprises the historical transaction data including the positive examples and the augmented data including the negative examples; and
training, by the computer system, the AI using the machine learning algorithm based on the training set.

2. The method of claim 1, wherein deriving, by the computer system, the augmented data from the historical transaction data comprises:
determining, by the computer system, a generative probability density function from the positive examples.

3. The method of claim 2, wherein deriving, by the computer system, the augmented data from the historical transaction data further comprises:
determining, by the computer system, an inversion of the generative probability density function; and
generating, by the computer system, the negative examples using the inversion of the generative probability density function.

4. The method of claim 2, wherein determining, by the computer system, the generative probability density function from the positive examples comprises:
finding, by the computer system, one or more Gaussian functions using the positive examples.

5. The method of claim 1, wherein the computer system enforces boundary limitations for values of the positive examples.

6. The method of claim 1, wherein deriving, by the computer system, the augmented data from the historical transaction data comprises:
limiting, by the computer system, a number of the negative examples that are derived based on a number of the positive examples.

7. The method of claim 1, wherein the negative examples are estimated by the computer system from a distribution of the positive examples.

8. The method of claim 1, wherein the historical transaction data comprises one or more of event data, inquiry data, competitor data, or transactional data.

9. The method of claim 1, further comprising:
storing the historical transaction data;
cleaning, by the computer system, the historical transaction data; and
transforming, by the computer system, the historical transaction data into a different format.

10. The method of claim 1, further comprising:
predicting, by the AI after the training, a set of prices corresponding to the set of resources.

11. The method of claim 10, further comprising:
determining, by the AI after the training, predicted demand for the set of resources, wherein the set of prices is predicted by the AI based on the predicted demand.

12. The method of claim 1, wherein training, by the computer system, the AI using the machine learning algorithm based on the training set, comprises:
training the AI using a classification algorithm that uses both the positive examples and the negative examples.

13. The method of claim 1, wherein the machine learning algorithm is a supervised learning algorithm.

14. A computer system for training an artificial intelligence (AI) implemented on the computer system, the computer system comprising:
one or more processors configured to:
receive, over a network, historical transaction data for a set of resources, wherein the historical transaction data includes positive examples relating to purchases of one or more resources of the set of resources;
derive augmented data from the historical transaction data, wherein the augmented data that is derived includes negative examples relating to fictional non-purchase decisions for the set of resources;
determine a training set for a machine learning algorithm for the AI, wherein the training set comprises the historical transaction data including the positive examples and the augmented data including the negative examples; and
train the AI using the machine learning algorithm based on the training set.

15. A non-transitory computer-readable medium for storing computer-readable instructions such that, when executed, cause a computer system to train an artificial intelligence (AI) implemented on the computer system by:
receiving, over a network, historical transaction data for a set of resources, wherein the historical transaction data includes positive examples relating to purchases of one or more resources of the set of resources;
deriving augmented data from the historical transaction data, wherein the augmented data that is derived includes negative examples relating to fictional non-purchase decisions for the set of resources;
determining a training set for a machine learning algorithm for the AI, wherein the training set comprises the historical transaction data including the positive examples and the augmented data including the negative examples; and
training the AI using the machine learning algorithm based on the training set.

16. The non-transitory computer-readable medium of claim 15, wherein deriving the augmented data from the historical transaction data comprises:
determining a generative probability density function from the positive examples.

17. The non-transitory computer-readable medium of claim 16, wherein deriving the augmented data from the historical transaction data further comprises:
determining an inversion of the generative probability density function; and
generating the negative examples using the inversion of the generative probability density function.

18. The non-transitory computer-readable medium of claim 16, wherein determining the generative probability density function from the positive examples comprises:
finding one or more Gaussian functions using the positive examples.

19. The non-transitory computer-readable medium of claim 15, wherein there are boundary limitations for values of the positive examples.

20. The non-transitory computer-readable medium of claim 15, wherein the negative examples are estimated from a distribution of the positive examples.
